(19) United States
(12) Patent Application Publication
(10) Pub. No.: US 2012/0238703 A1
(43) Pub. Date: Sep. 20, 2012

(54) THERMOSETTING COMPOSITIONS CATALYZED WITH PHOSPHOTUNGSTIC ACID

(75) Inventors: Ken W. Niederst, Allison Park, PA (US); Gregory J. McCollum, Gibsonia, PA (US); Michael A. Zalich, Pittsburgh, PA (US); Venkateshwarlu Kalsani, Allison Park, PA (US)

(73) Assignee: PPG Industries Ohio, Inc., Cleveland, OH (US)

(21) Appl. No.: 13/048,051

(22) Filed: Mar. 15, 2011

(51) Int. Cl. C08L 33/14; C08J 3/24; C08F 220/28

(52) U.S. Cl. 525/223; 525/328.8

(57) ABSTRACT

A thermosetting composition comprising (1) a resinous binder having hydroxyl groups and carboxylic ester groups, and (2) phosphotungstic acid.

### FIELD OF THE INVENTION

The present invention relates to thermosetting compositions in which the curing reaction is catalyzed with phosphotungstic acid. More particularly, the invention relates to thermosetting compositions in which the resinous binder comprises hydroxyl groups and carboxylic ester groups and in which the resinous binder undergoes a curing reaction in the presence of phosphotungstic acid.

### BACKGROUND OF THE INVENTION

Thermosetting compositions comprise a resinous ingredient having reactive functional groups such as hydroxyl groups and an ingredient that has co-reactive functional groups such as methylol or methylol ether groups in aminoplasts and phenolplasts and isocyanate groups in polyisocyanates. However, such curing agents are problematic. Aminoplasts and phenolplasts can contain free formaldehyde and release formaldehyde during the curing process. Chronic formaldehyde exposure can cause serious respiratory problems. Polyisocyanate curing agents must be handled with great care, since they can cause respiratory and sensitization problems. Consequently, there is a strong desire to eliminate these compounds from thermosetting compositions. Accordingly, what is desired are thermosetting compositions that are curable without the need for formaldehyde condensate or polyisocyanates and yet have excellent cured film properties

Transesterification of a simple ester compound with a simple alcohol compound is known to occur under basic conditions. The transesterification reaction is an equilibrium reaction which can be driven to completion by removing the alcohol moiety evolving from the cleaved ester. If the cleaved alcohol moiety is a low molecular weight lower alkyl alcohol such as methanol or ethanol, removal by evaporation is quite easy. It has been found that transesterification as a curing mechanism for crosslinking polymers used in paint coatings provides an attractive cure mechanism for producing thermosetting protective coatings, since cleaved lower alkyl alcohols can be easily removed from the coating by simple evaporation thereby driving the transesterification reaction to completion. Also, transesterification cure does not rely on formaldehyde condensate curing agents or polyisocyanates.

However, transesterification cure can, depending on the choice of catalyst reactants, often require high temperature and can have discoloration problems. What is desired is a catalyst that provides reasonably low temperature cure without discoloration with a variety of reactants.

### SUMMARY OF THE INVENTION

The present invention relates to thermosetting resinous compositions comprising:
(1) a resinous binder having hydroxyl groups and carboxylic ester groups, and
(2) phosphotungstic acid.

### DETAILED DESCRIPTION

As used herein, unless otherwise expressly specified, all numbers such as those expressing values, ranges, amounts or percentages may be read as if prefaced by the word “about”, even if the term does not expressly appear. Moreover, it should be noted that plural terms and/or phrases encompass their singular equivalents and vice versa. For example, “a” polymer, “a” crosslinker, and any other component refers to one or more of these components.

When referring to any numerical range of values, such ranges are understood to include each and every number and/or fraction between the stated range minimum and maximum.

As employed herein, the term “polyol” or variations thereof refers broadly to a material having an average of two or more hydroxyl groups per molecule. The term “polycarboxylic acid” refers to the acids and functional derivatives thereof, including anhydride derivatives where they exist, and lower alkyl esters having 1-4 carbon atoms.

As used herein, the term “polymer” refers broadly to prepolymers, oligomers and both homopolymers and copolymers. The terms “resin” and “polymer” and “resinous” and “polymeric” are used interchangeably.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, ethacrylic acid, etc., and their C₁-C₅ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “acrylic polymer” refers to polymers prepared from one or more (meth)acrylic monomers. “Lower alkyl” acrylate refers to alkyl groups of 1 to 4 carbon atoms.

As used herein, “a” and “the at least one” and “one or more” are used interchangeably. Thus, for example, a coating composition that comprises “a” polymer can be interpreted to mean the coating composition includes “one or more” polymers.

As used herein, molecular weights are determined by gel permeation chromatography using a polystyrene standard. Unless otherwise indicated, molecular weights are on a number average basis (Mₙ).

The resinous binder can consist of one or more ingredients and has both hydroxyl groups and carboxylic ester groups such as lower alkyl ester groups and beta-hydroxyester groups. These groups can be present in the same resinous ingredient or can be present in separate ingredients. Also, the groups can be present in the same moiety such as with beta-hydroxyester groups that contain the desired hydroxyl group and the carboxylic ester group. Among the resinous binders that may be used are polyesters, resins derived from polyepoxides and acrylic polymers.

Examples of polyesters are polyesters with terminal lower alkyl ester groups that may be monomeric or polymeric in nature. Examples include diesters and/or polyesters with terminal ester groups of low boiling alcohols. Useful aliphatic diesters include dimethyl glutarates, dimethyl succinate, diethyl succinate, dimethyl adipate, diethyl adipate, diisopropyl sebacate and the like. Aromatic esters of use include dimethyl isophthalate, dimethyl terephthalate, diethyl isophthalate, diethyl terephthalate, trimethyl-1,3,5-benzene tricarboxylate, trimethyl-1,3,5-naphthalene tricarboxylate and the like. Cycloaliphatic esters can include, for example, dimethyl, diethyl or dipropyl 1,4-cyclohexane dicarboxylate, 1,3-cyclohexane dicarboxylate, and trimethyl-1,3,5-cyclohexane tricarboxylate.

Polyesters with terminal lower alkyl groups can be prepared by reacting the diesters as described above with diols and triols.

Examples of esters derived from polyepoxides are beta-hydroxyester group-containing polymers prepared from polyepoxides by reaction with a carboxylic acid such as monomethyl esters of dicarboxylic acids.

Examples of acrylic polymers are those prepared by copolymerizing (meth)acrylic monomers containing lower alkyl (meth)acrylate groups such as methyl (meth)acrylate, ethyl (meth)acrylate and butyl (meth)acrylate and/or (meth)acrylic monomers containing beta-hydroxyester groups such as hydroxyethyl (meth)acrylates and hydroxypropyl (meth)acrylates with other copolymerizable ethylenically unsaturated monomers. Examples of other copolymerizable ethylenically unsaturated monomers include vinyl monomers such as vinyl esters, vinyl halides, vinyl aromatic compounds, vinyl aliphatic hydrocarbons, vinyl conjugated dienes and vinyl ethers and allylic monomers. Vinyl esters include vinyl acetate, vinyl propionate, vinyl butyrates, vinyl benzoates, vinyl isopropyl acetates, and similar vinyl esters. Vinyl halides include vinyl chloride, vinyl fluoride, and vinylidene chloride. Vinyl aromatic hydrocarbons include styrene, methyl styrenes, and similar lower alkyl styrenes, chlorostyrene, vinyl toluene, vinyl naphthalene, divinyl benzoate, and cyclohexene. Vinyl aliphatic hydrocarbon monomers include alpha olefins such as ethylene, propylene, isobutylene, and cyclohexyl as well as conjugated dienes such as butadiene, methyl-2-butadiene, 1,3-piperylene, 2,3-dimethyl butadiene, isoprene, cyclopentadiene, and dicyclopentadiene. Vinyl alkyl ethers include methyl vinyl ether, isopropyl vinyl ether, n-butyl vinyl ether, and isobutyl vinyl ether. Examples of allylic monomers include allyl alcohol and allyl chloride.

The acrylic polymer can be prepared by conventional solution polymerization techniques using free radical initiators such as azo or peroxide catalyst.

Typically the acrylic polymer contains from 10 to 90 percent by weight of units derived from beta-hydroxy alkyl (meth)acrylates and/or lower alkyl (meth)acrylates with the remainder 10 to 90 percent being derived from other copolymerizable ethylenically unsaturated monomers. Usually the acrylic polymer contains from 10 to 70 percent by weight of the beta-hydroxy alkyl (meth)acrylate; 25 to 85 percent by weight of lower alkyl (meth)acrylates and 5 to 65 percent by weight of other copolymerizable ethylenically unsaturated monomers. The percentage by weight is based on total weight of the monomers used in preparing the acrylic polymer.

The carboxylic ester component can have a molecular weight as low as 150 in the case of simple diesters, to as high as 100,000, more typically as high as 50,000, in the cases of polymeric materials. The carboxylic ester component typically has a lower alkyl ester content of 0.0015 to 0.0050 moles of ester per gram of carboxylic ester.

The resinous binder also contains hydroxyl functionality that can be provided to the resinous binder by the use of polymeric polyols that can be selected from a wide variety of hydroxyl group-containing polymers such as hydroxy functional alkyd resins, polyester polyols, polyurethane polyols and hydroxy functional polymers derived from epoxy resins, and acrylic polyols. Such materials are described in U.S. Pat. No. 4,546,045, col. 2, line 37 to col. 4, line 46; the portions of which are hereby incorporated by reference.

The polymeric polyols can have number average molecular weights as low as about 200 and as high as about 100,000, but preferably are usually in the range of about 500 to 50,000. The hydroxyl content of the polymeric polyol should be sufficient to cure to a solvent-resistant coating. Generally, the polymeric polyol has a hydroxyl content of 0.0015 to 0.0050 moles of hydroxyl per gram of polymeric polyol, although higher hydroxyl contents may be used.

Thermosetting compositions can be formulated from one or more of the various ester-containing components and one or more of the hydroxyl-containing components. Generally, the composition will be formulated with about equal quantities of the co-reactive esters and hydroxyl-containing components, although other ratios are useful. Polymers with both hydroxyl and lower alkyl ester functionality and/or beta-hydroxy alkyl functionality can be made self-curing since the hydroxyl groups and the carboxylic ester groups are in the same component. In the case of beta-hydroxyester groups, they are in the same moiety. For example, polyesters can be prepared by (1) transesterification of diesters and polyesters with diols and triols, and (2) esterification of polycarboxylic acids with polyols to form low acid number hydroxyl-containing polyesters followed by transesterification with lower alkyl diesters of carboxylic acids. Other examples include the beta-hydroxyester group containing polymers prepared from polyepoxides. The secondary hydroxyl group in the backbone of the polymer participates in the transesterification crosslinking reaction with the epoxy ester functionality. Acrylic polymers containing beta-hydroxy (meth)acrylate groups can be made self-curing since the beta-hydroxy alkyl moiety contains both hydroxy and beta-hydroxyester functionality. Preferred self-curing acrylic polymers contain both beta-hydroxyester groups and lower alkyl ester groups.

Also present in the thermosetting composition is phosphotungstic acid that is present in catalytic amounts generally from 0.5 to 5.0 percent by weight based on weight of resin solids.

The thermosetting compositions do not depend on curing agents that have groups that are co-reactive with hydroxyl groups. Such groups are defined as formaldehyde condensates such as aminoplasts that are condensates of triazines with formaldehyde; phenolplasts that are condensates of phenols with formaldehyde and isocyanate curing agents. The thermosetting compositions are substantially free of such curing agents, preferably essentially free, and may even be completely free.

The term “substantially free” means the compositions of the present invention contain less than 1000 parts per million (ppm) of the recited compound. The term “essentially free” of a particular compound means the compositions contain less than 5 ppm of the recited compound. The term “completely free” of a particular compound means that the compositions contain less than 20 parts per billion (ppb) of the recited compound.

The thermosetting compositions can be formulated into coating compositions, either clear coating compositions or, alternately, they can be formulated with pigments to form paints. The pigments may be any of the conventional types comprising, for example, iron oxides, lead oxides, strontium chromate, carbon black, coal dust, titanium dioxide, talc, barium sulfate, as well as color pigments such as cadmium yellow, cadmium red, chromium yellow and metallic pigments such as aluminum flake.

The pigment content of the paint is usually expressed as the pigment-to-resin weight ratio. In the practice of the invention, when the film-forming coating compositions of the present invention contain pigment, the pigment-to-resin weight ratios may be as high as 2:1, and for most pigmented coatings are about 0.1 to 1.0.

Curing temperatures are about 90° C. to 200° C., and in most cases, a cure schedule is from about 1 to 60 minutes. Higher or lower temperatures (such as room temperature) with correspondingly shorter or longer times can be utilized, although the exact cure schedule best employed depends upon the particular components used in formulating the coating compositions.

The dry film thickness of the resultant coating is typically about 0.5 to 5.0 mils (12.7-127 microns), such as 1.0 to 2.5 mils (25.4-63.5 microns).

### EXAMPLES

The following examples are offered to aid in understanding of the present invention and are not to be construed as limiting the scope thereof. Unless otherwise indicated, all parts and percentages are by weight.

### Examples 1-4

In these examples, four coatings were prepared using an acrylic copolymer with ester and hydroxyl functionality, which was reduced to 40% solids using a mixture of Aromatic 100 and methyl amyl ketone (weight ratio of 50:50): 1) a control coating without catalyst, 2) a coating catalyzed with 2% by weight (of titania based on weight of resin solids) of titanium isopropoxide, 3) a coating catalyzed with 2% by weight (of titania based on weight of resin solids) of titanium n-butoxide and 4) a coating catalyzed with 2.5% by weight (based on weight of resin solids) of phosphotungstic acid(PTA). Coatings were drawn down using a #6 wire wound bar and baked for 12 minutes at 400° F. (204° C.). The coatings were evaluated for cure by rubbing with a methyl ethyl ketone saturated cloth. The results are reported in the Table below.

| Example | Acrylic resin¹ | Catalyst | MEK double rubs |
|---|---|---|---|
| 1 | HEA/HEMA/STY/EA | None | 5 |
| 2 | HEA/HEMA/STY/EA | Ti (IpOH) | 6 |
| 3 | HEA/HEMA/STY/EA | Ti (nBuO) | 100 |
| 4 | HEA/HEMA/STY/EA | PTA | 100 |

¹The acrylic resin containing ester and hydroxyl functionality was prepared using conventional solution polymerization techniques using Luperox 575 as a catalyst. The resin had a hydroxylethyl acrylate(HEA)/hydroxylethyl methacrylate (HEMA)/styrene(STY)/ethyl acrylate(EA) weight ratio of 15/17/42/26. The resin had a solids content of 59.3% in a mixture of Aromatic 100 and methyl amyl ketone (weight ratio of 50:50), a number average molecular weight (Mₙ) of about 5923 g · mol⁻¹ and a weight average molecular weight (M_{w}) of about 20061 g · mol⁻¹.

### Examples 5-12

In these Examples, an ester-containing resin of styrene/butyl acrylate/dimethyl itaconate (34/16/50 weight ratio) was blended with a hydroxyl functional resin of hydroxy butyl acrylate/styrene/2-ethylhexyl acrylate/methyl methacrylate/butyl methacrylate (22/22/10/26/20 weight ratio). The blend was formulated into three coating compositions by adding 0.5% by weight (of titania based on weight of resin solids) of titanium isopropoxide catalyst, 0.5% by weight (of titania based on weight of resin solids) of titanium n-butoxide catalyst and 1% by weight of phosphotungstic acid catalyst, respectively. Coatings were drawn down using a 2-mil drawdown bar and baked for 12 or 30 minutes at 400° F. (204° C.). The coatings were evaluated for cure by rubbing with a methyl ethyl ketone saturated cloth. The results are reported in Table I below.

TABLE I
Coating Formulations Using an Ester Functional Resin and a Hydroxyl Functional Resin

| | | | | | | | | MEK |
|---|---|---|---|---|---|---|---|---|
| Example | | | | | | Cure | Cure Time in | Double |
| No. | Ester Resin | Mole Ester/g | OH Resin | Mole OH/g | Catalyst | Temperature | minutes | Rubs³ |
| 5 | STY/BA/DMI¹ | 0.0032 | HBA/STY/2-EHA/ | 0.0015 | Ti (IpOH) | 400° F. (204° C.) | 12 | 6 |
| | | | MMA/BMA² | | | | | |
| 6 | ″ | ″ | HBA/STY/2-EHA/ | ″ | Ti (nBuO) | ″ | ″ | >100 |
| | | | MMA/BMA² | | | | | |
| 7 | ″ | ″ | HBA/STY/2-EHA/ | ″ | PTA | ″ | ″ | 6 |
| | | | MMA/BMA² | | | | | |
| 8 | ″ | ″ | HBA/STY/2-EHA/ | ″ | None | ″ | ″ | 4 |
| | | | MMA/BMA² | | | | | |
| 9 | STY/BA/DMI | 0.0022 | HBA/STY/2-EHA/ | ″ | Ti (IpOH) | 400° F. (204° C.) | 30 | 40 |
| | | | MMA/BMA² | | | | | |
| 10 | ″ | ″ | HBA/STY/2-EHA/ | ″ | Ti (nBuO) | ″ | ″ | 60 |
| | | | MMA/BMA² | | | | | |
| 11 | ″ | ″ | HBA/STY/2-EHA/ | ″ | PTA | ″ | ″ | 6 |
| | | | MMA/BMA² | | | | | |
| 12 | ″ | ″ | HBA/STY/2-EHA/ | ″ | None | ″ | ″ | 3 |
| | | | MMA/BMA² | | | | | |

¹The ester-containing resin was prepared by conventional solvent-based solution polymerization techniques using t-butyl peroctoate catalyst. The resin had a styrene/butyl acrylate/dimethyl itaconate weight ratio of 34/16/50. The resin had a solids content of 56% in a mixture of dipropylene glycol dimethyl ether and methyl ethyl ketone (weight ratio of 63.5/36.5); a number average molecular weight (Mₙ) of about 4600 g·mol⁻¹ and a weight average molecular weight (M_{w}) of about 13,800 g·mol⁻¹.
²The hydroxyl-containing resin was prepared by conventional solvent-based solution polymerization techniques using di t-butyl peroxide catalyst. The resin had a hydroxy butyl acrylate/styrene/2-ethyl hexyl acrylate/methyl methacrylate/butyl methacrylate weight ratio of 22/22/10/26/20. The resin had a solids content of 64.97% in AROMATIC 100; a number average molecular weight (Mₙ) of 2918 g · mol⁻¹ and a weight average molecular weight (M_{w}) of 9979 g·mol⁻¹.
³Rubbing back and forth with a cotton cloth saturated with methyl ethyl ketone (MEK).
STY = Styrene,
BA = Butyl acrylate,
DMI = Dimethyl itaconate,
HBA = Hydroxy butyl acrylate,
2-EHA = 2-Ethyl hexyl acrylate,
MMA = Methyl methacrylate,
BMA = Butyl methacrylate,
Ti (IpOH) = Titanium (tetra-isopropoxide),
Ti (nBuO) = Titanium (tetra-n-butoxide), and
PTA = Phosphotungstic acid.

### Examples 13-16

A second series of experiments was conducted using an ester/hydroxyl functional resin. The ester/hydroxyl functional resin comprised hydroxypropyl acrylate/styrene/methyl methacrylate/butyl methacrylate/butyl acrylate/acrylic acid in a 40/20/0.5/18.5/19.0/2.0 weight ratio. The resin was prepared by conventional solution polymerization techniques using di t-amyl peroxide catalyst and AROMATIC 100/propylene glycol monomethyl ether acetate (40/60 weight ratio) solvent. The resin had a solids content of about 67% and an M_{w} of 8560 g·mol⁻¹. Three coating compositions were formulated by adding 0.5% by weight (of titania based on weight of resin solids) of titanium (tetra-isopropoxide) catalyst, 0.5% by weight (of titania based on weight of resin solids) of titanium (tetra-n-butoxide) catalyst and 1% (by weight based on weight of resin solids) phosphotungstic acid catalyst. The compositions were drawn down using a 2-mil drawdown bar and baked for 12 or 30 minutes at 300 and 400° F. (149 and 204° C.). A control coating without catalyst was prepared by baking for 12 minutes at 400° F. The coatings were evaluated for cure by rubbing with an MEK-saturated cloth. The results are reported in Table II below.

TABLE II
Coating Formulations Using an Ester/Hydroxyl Functional Resin,
Where X Denotes which Catalyst was Employed

| | | | | MEK Double | MEK Double | MEK Double | MEK Double |
|---|---|---|---|---|---|---|---|
| | | | | Rubs 12 | Rubs 12 | Rubs 30 | Rubs 30 |
| | | | | minutes @ | minutes @ | minutes @ | minutes @ |
| Example | Ti | Ti | | 300° F. | 400° F. | 300° F. | 400° F. |
| No. | (IpOH) | (nBuO) | PTA | (149° C.) | (204° C.) | (149° C.) | (204° C.) |
| 13 | X | | | 5 | 100 | 5 | 100 |
| 14 | | X | | 4 | 57 | 7 | 100 |
| 15 | | | X | 33 | 100 | 100 | 100 |
| 16 | | | | | 6 | | |

### Examples 17-22

The following Examples show curing of various ester/hydroxyl functional acrylic polymers. The polymers were prepared by conventional solution polymerization techniques in an aromatic solvent and using either di t-butyl or di t-amyl peroxide catalyst. The polymers had a solids content of about 66-70%, Mₙ values of 1600-3000 g·mol⁻¹ and M_{w} values of 4000-10,000 g·mol⁻¹. Four coating compositions were each formulated with 3% by weight based on resin solids of phosphotungstic acid. The coatings were drawn down on primed steel substrates with a 5-mil bird bar, flashed for 10 minutes and then cured at 140° C. for 30 minutes. After 24 hours, the films were tested for cure using MEK double rubs. The results are reported in Table 111 below.

TABLE III
Coating Formulations Using an Ester/Hydroxyl Functional Acrylic Polymer

| | | | | | | | | | | | | | | Solvent |
|---|---|---|---|---|---|---|---|---|---|---|---|---|---|---|
| | | | | | | | | | | OH | | Functionality | | Resistance, |
| Example | | % | Monomer Composition | | | | | | | Value (on | Equivalent | (OH-eq/Kg- | M_{w} | MEK double |
| No. | Resin | Solids | HEA | BA | STY | MMA | HPA | BMA | AA | solution) | Weight | resin) | (g · mol⁻¹) | rubs |
| 17 | — | 67 | | 19 | 20 | 0.5 | 40 | 18.5 | 2.0 | 111.5 | 503.1 | 3.0 | 8557 | >100 |
| 18 | — | 66.7 | 30 | 60 | 10 | | | | | 92.9 | 603.9 | 2.5 | 4076 | 93 |
| 19 | — | 67.87 | 35 | 25 | 35 | 5 | | | | 113.2 | 495.6 | 3.0 | 10088 | >100 |
| 20 | — | 69.18 | 35 | 40 | 25 | | | | | 106.9 | 524.8 | 2.8 | 9540 | >100 |
| 21 | HPH-7700 | 90 | | | | | | | | | | | | 5 |
| (com- | (polyester)¹ | | | | | | | | | | | | | |
| parative) | | | | | | | | | | | | | | |
| 22 | Polybutyl | 60 | | | | | | | | | | | | 2 |
| (com- | acrylate² | | | | | | | | | | | | | |
| parative) | | | | | | | | | | | | | | |

¹Polyester was a condensate of hexahydrophthalic anhydride and neopentyl glycol (42.5/57.5 weight ratio) having a hydroxyl value of 275-300 and number average molecular weight (Mₙ) of 300-400 g·mol⁻¹.
²Polybutyl acrylate in xylene solvent available from DuPont as RK-5345.
HEA = Hydroxyethyl acrylate,
BA = Butyl acrylate,
STY = Styrene,
MMA = Methyl methacrylate,
HPA = Hydroxypropyl acrylate,
BMA = Butyl methacrylate and
AA = Acrylic acid.

Example 10 was repeated but the coating composition contained no phosphotungstic acid catalyst. The resultant coating had 5 MEK double rubs.

### Examples 23-31

The following Examples show curing of various ester/hydroxyl functional acrylic polymers. The polymers were prepared by conventional solution polymerization techniques in methyl isobutyl ketone using a peroxide catalyst (LUPEROX 575). The polymers had a solids content of 40% by weight. Coating compositions were formulated with 1, 2 and 4% by weight phosphotungstic acid based on weight of resin solids. The coatings were drawn down with a #18 wire wound drawbar over steel substrates and cured for 10 minutes at 400° F. (204° C.). The films were tested for cure using MEK double rubs. The results are reported in Table IV below.

TABLE IV
Coatings Formulated with Ester/Hydroxyl Functional Acrylic Polymers

| Example | Monomer Composition | | | | % | Mₙ | MEK Double |
|---|---|---|---|---|---|---|---|
| No. | STY | HEA | BA | AA | PTA | (g · mol⁻¹) | Rubs |
| 23 | 40 | 30 | 30 | | 1 | 4930 | 65 |
| 24 | 40 | 30 | 30 | | 2 | 4930 | >100 |
| 25 | 40 | 30 | 30 | | 4 | 4930 | >100 |
| 26 | 30 | 30 | 30 | 10 | 1 | 12,233 | >100 |
| 27 | 30 | 30 | 30 | 10 | 2 | 12,233 | >100 |
| 28 | 30 | 30 | 30 | 10 | 4 | 12,233 | >100 |
| 29 | 70 | 30 | | | 1 | 5479 | >100 |
| 30 | 70 | 30 | | | 2 | 5479 | >100 |
| 31 | 70 | 30 | | | 4 | 5479 | >100 |

STY = Styrene,
HEA = Hydroxyethyl acrylate,
BA = Butyl acrylate,
AA = Acrylic acid, and
PTA = Phosphotungstic acid.

1. A thermosetting composition comprising:
(a) a resinous binder having hydroxyl groups and carboxylic ester groups, and
(b) phosphotungstic acid.

2. The thermosetting composition of claim 1 in which the carboxylic ester groups are selected from lower alkyl ester groups and beta-hydroxyester groups.

3. The thermosetting composition of claim 2 in which the lower alkyl ester groups are derived from dimethyl itaconate.

4. The thermosetting composition of claim 1 in which the hydroxyl groups and the carboxylic ester groups are in the same component of the resinous binder.

5. The thermosetting composition of claim 1 in which the hydroxyl groups and the carboxylic ester groups are in the same moiety.

6. The thermosetting composition of claim 5 in which the hydroxyl groups and carboxylic ester groups are present as beta-hydroxyester groups.

7. The thermosetting composition of claim 1 in which the resinous binder comprises:
(i) a polymer containing beta-hydroxyester groups, and/or lower alkyl ester groups, and
(ii) a polymer different from (i) containing hydroxyl groups.

8. The thermosetting composition of claim 7 in which (i) and (ii) are acrylic polymers.

9. The thermosetting composition of claim 1 in which the resinous binder comprises:
(i) a polymer containing hydroxyl groups, and
(ii) a compound or polymer containing lower alkyl ester groups.

10. The thermosetting composition of claim 1 in which (b) is present in amounts of 0.5 to 5.0 percent by weight based on weight of resin solids.

11. The thermosetting composition of claim 1 which is essentially free of curing agents that have groups that are co-reactive with hydroxyl groups.

12. The thermosetting composition of claim 1 which is substantially free of aminoplasts, phenolplasts and isocyanate curing agents.
